(19) United States
(12) Patent Application Publication
(10) Pub. No.: US 2021/0350424 A1
(43) Pub. Date: Nov. 11, 2021

(54) CONSUMER TRACKING SYSTEM

(71) Applicant: YUMPINGO LTD, London (GB)

(72) Inventors: George WETZ, London (GB); Gary GOODMAN, London (GB)

(21) Appl. No.: 17/277,689

(22) PCT Filed: Sep. 20, 2019
(86) PCT No.: PCT/GB2019/052649

§ 371 Date: Mar. 18, 2021

(30) Foreign Application Priority Data
Sep. 21, 2018 (GB) 1815434.4

(51) Int. Cl. G06Q 30/02; G06Q 20/32; G06Q 20/20; G06Q 50/12

(52) U.S. Cl. CPC G06Q 30/0282; G06Q 30/0203; G06Q 20/3223; G06Q 50/12; G06Q 20/3278; G06Q 20/20; G06Q 20/3276

(57) ABSTRACT

The present invention relates to a computer implemented method, the method comprising: receiving, on a local computing device (130), configuration data identifying a transaction or service provided to a user; wherein the configuration data is arranged to enable a user device (120) to access a payment request in respect of the transaction or service and an identifier dependent on the transaction data; wherein the identifier comprises server access information adapted to enable the user device to access a server (140) with the identifier thereby enabling an association or link to be made at the server (140) between the user device (120) and review data in respect of the transaction or service.

The present invention relates to a method of and apparatus for tracking consumer interaction and sentiment across a plurality of discrete encounters. The invention has particular application in restaurant reviews. Other applications are also envisaged.

Generally, it can be a challenge for service and/or goods providers to track consumer interaction and sentiment across a plurality of discrete encounters. The reverse is also true, it is difficult for consumers to track their own interactions with service providers. It is desirable both from the consumer perspective and service and/or goods provider perspective to use past interactions to inform any future interactions they may have. Such insight requires the ability to collect information regarding consumer-provider interaction efficiently, and is improved greatly or even enabled if the user can be identified.

From the consumer perspective, this can be technically challenging as it requires the consumer to perform data collection across a multitude of vendors each of which may utilise different technologies to provide their services or goods. It is also technically challenging from the perspective of the service and/or goods provider who may, for example deal with thousands of consumers across thousands of geographically locations in a single day.

The object of the proposed system is to enable the tracking of consumer interaction and sentiment across a plurality of discrete encounters. The gathered data may be analysed and the results of any analysis may be communicated to either the service provider or the consumer or indeed to both parties.

For example, restaurants, cafes, bars and other food or beverage establishments regularly utilise customer feedback and reviews. However, it is often difficult to get customers to engage with and complete such reviews or feedback forms. These forms or reviews are, more often than not, presented to a customer in paper form with their bill or in electronic form in an email after they have left the restaurant. These reviews usually contain a standard set of questions which may be unrelated to the customer's experience in the restaurant. This regularly results in a low completion rate and, even in the circumstances where a review is completed, the information gathered by the restaurant exists in total isolation to other potentially useful information, such as the information from the bill associated with that customer. In addition, whilst the restaurant may utilise the review data provided by the customer, the customer is not provided with any feedback regarding their own recorded experiences, which may have occurred across many different establishments each of which potentially owned and run by different organisations.

Aspects and embodiments of the present invention are set out in the appended claims. These and other aspects and embodiments of the invention are also described herein.

According to an aspect of the invention there is provided a method performed on a local computing device, the method comprising: receiving configuration data identifying a transaction or service provided to a user; requesting and receiving from a remote server in dependence on the configuration data transaction data relating to the transaction or service; requesting and receiving from the user review data in respect of the transaction or service and forwarding said review data to the server; and transmitting to the user device a payment request in respect of the transaction or service and an identifier dependent on the transaction data; wherein the identifier comprises server access information adapted to enable the user device to access the server with the identifier thereby enabling an association or link to be made at the server between the user device and the review data in respect of the transaction or service.

Preferably, the configuration data is at least one of: received via direct input at the local computing device, received from a remote server and/or determined in dependence on proximity or location data.

Preferably, the review data is requested from the user via a review interface, the interface generated by the local computing device or received from the server.

Preferably, the identifier is generated by the local computing device or received from the server.

Preferably, the identifier and server access information are encoded into a transport medium readable by the user device such as a barcode, QR code, URL and/or transmitted via a wireless protocol such as NFC or Bluetooth.

Preferably, the server access information comprises instructions to the user device to access the server.

Preferably, the method further comprises forwarding to the user device further data in dependence on at least one of: review data and/or transaction data.

According to another aspect of the invention there is provided a local computing device, the device comprising: means for receiving configuration data identifying a transaction or service provided to a user (e.g. a user interface and/or communications interface); means for requesting and receiving from a remote server in dependence on the configuration data transaction data relating to the transaction or service (e.g. a communications interface); means for requesting and receiving from the user review data in respect of the transaction or service and forwarding said review data to the server (e.g. a user interface and/or communications interface); and means for transmitting to the user device a payment request in respect of the transaction or service and an identifier dependent on the transaction data (e.g. a communications interface); wherein the identifier comprises server access information adapted to enable the user device to access the server with the identifier thereby enabling an association or link to be made at the server between the user device and the review data in respect of the transaction or service.

The local computing device is typically implemented on a computer device that comprises:
a processing unit (e.g. a CPU);
a storage capability, such as a hard drive and/or a solid-state drive (SDD);
a communications interface, such as a QR code reader, a Bluetooth™ interface, a near filed communications (NFC) interface, an Ethernet interface, or a WiFi interface; and
a user interface, such as a touchscreen and/or a keyboard.

Each means of the computer device may be one of the components of the computer device.

Preferably, the configuration data is arranged to enable the user device to request and receive transaction data relating to the transaction or service.

Preferably, the configuration data is arranged to enable the user device to request and receive forward review data from the user in respect of the transaction or service to the server.

Preferably, wherein the configuration data is arranged to enable the user to access a review interface, the interface being received from the server.

Preferably, the configuration data is at least one of: received via direct input at the local computing device, received from a remote server and/or determined in dependence on proximity or location data.

Preferably, the identifier is generated by the local computing device or received from the server.

Preferably, the identifier and server access information are encoded into a transport medium readable by the user device such as a barcode, QR code, URL and/or transmitted via a wireless protocol such as NFC or Bluetooth.

Preferably, the server access information comprises instructions to the user device to access the server.

Preferably, the local computing device further comprises means for forwarding to the user device further data in dependence on at least one of: review data and/or transaction data (e.g. a communications interface).

According to another aspect of the invention there is provided a method performed on a computer server, the method comprising: providing, in response to a request received from a local computing device, transaction data relating to the transaction or service provided to a user; receiving from the local computing device review data in respect of the transaction or service; receiving a connection request from a user device, the request comprising an identifier provided by the local computing device and dependent on the transaction data; and associating the user device to the review data in respect of the transaction or service.

Preferably, the method further comprises: receiving configuration data identifying a transaction or service from the local computing device; and requesting and receiving transaction data relating to the transaction or service from an external entity such as a point-of-sale system.

According to another aspect of the invention there is provided a computer server, the server comprising: means for providing, in response to a request received from a local computing device or a user device, transaction data relating to the transaction or service provided to a user; means for receiving from the local computing device or the user device review data in respect of the transaction or service; means for receiving a connection request from a user device, the request comprising an identifier provided by the local computing device and dependent on the transaction data; and means for associating the user device to the review data in respect of the transaction or service.

Preferably, the server further comprises: means for receiving configuration data identifying a transaction or service from the local computing device; and means for requesting and receiving transaction data relating to the transaction or service from an external entity such as a point-of-sale system.

According to yet another aspect of the invention there is provided a system comprising a local computing device and a server as described.

According to yet further aspect of the invention there is provided a computer program and computer program product comprising computer code which when executed is adapted to perform a method as described.

According to yet another further aspect of the invention there is provided a computer program and computer program product comprising computer code which when executed is adapted to enable a user device to interact with the system as described.

According to another aspect of the invention, there is provided a computer implemented method, the method comprising: receiving, on a local computing device, configuration data identifying a transaction or service provided to a user; wherein the configuration data is arranged to enable a user device to access a payment request in respect of the transaction or service and an identifier dependent on the transaction data; wherein the identifier comprises server access information adapted to enable the user device to access a server with the identifier thereby enabling an association or link to be made at the server between the user device and review data in respect of the transaction or service.

Preferably, the method further comprises requesting and receiving, either on the local computing device or on the user device, from a remote server in dependence on the configuration data transaction data relating to the transaction or service; requesting and receiving, either on the local computing device or on the user device, from the user review data in respect of the transaction or service and forwarding said review data to the server; and transmitting to the user device a payment request in respect of the transaction or service and an identifier dependent on the transaction data.

Preferably, the method further comprises transmitting the configuration data to the user device.

According to another aspect of the invention, there is provided a local computing device, the device comprising: means for receiving configuration data identifying a transaction or service provided to a user; means for transmitting to the user device the configuration data, wherein the configuration data is arranged to enable the user device to access a payment request in respect of the transaction or service and an identifier dependent on the transaction data; wherein the identifier comprises server access information adapted to enable the user device to access the server with the identifier thereby enabling an association or link to be made at the server between the user device and the review data in respect of the transaction or service.

Preferably, the configuration data is arranged to enable the user device to request and receive transaction data relating to the transaction or service. Preferably, the configuration data is arranged to enable the user device to request and receive forward review data from the user in respect of the transaction or service to the server.

Preferably, the configuration data is arranged to enable the user to access a review interface, the interface being received from the server.

According to another aspect of the invention, there is provided: a method performed on a computer server, the method comprising: providing, in response to a request received from a local computing device, transaction data relating to the transaction or service provided to a user; receiving, from the local computing device or a user device, review data in respect of the transaction or service; receiving a connection request from the user device, the request comprising an identifier provided by the local computing device and dependent on the transaction data; and associating the user device to the review data in respect of the transaction or service.

There is also provided a portable device comprising a local computing device as aforesaid.

There is also provided an apparatus arranged to carry out a method as aforesaid.

There is also provided a portable apparatus arranged to carry out a method as aforesaid.

There is also provided a method of associating a user and a review using a method as aforesaid.

There is also provided an apparatus adapted to execute a computer program product as aforesaid.

There is also provided a system, method, and apparatus as herein described and/or as illustrated with reference to the accompanying drawings.

Aspects of the invention may include:
A method of associating restaurant review data with a user device comprising: creating a transient identification (ID) for said review data; tagging said review data with the transient ID; transmitting said tagged review data to a user device; associating said user device with said tagged review data.
A method wherein a server creates a transient ID and transmits said transient ID to a local computing system.
A method wherein the local computing system creates a transient ID.
A method wherein the server associates a transient ID with review data, transaction data and metadata.
A method wherein a local computing system associates a transient ID, review data, transaction data and metadata and transmits said transient ID, review data, transaction data and metadata to a server.
A method wherein a server associates and stores the transient ID, review data, transaction data and metadata on a database.
A method wherein the local computing system encodes the review data, transaction data, metadata and transient ID into a transport medium.
A method wherein the local computing system encodes a transient ID into a transport medium for example a matrix barcode, a barcode, a URL and alphanumeric code, a URL, Near-field communication or Bluetooth.
A method wherein the user device decodes the encoded data.
A method wherein the decoded data registers the user device with the server using the transient ID.
A method wherein the user device generates a unique identification.
A method wherein the user device transmits the unique identification from a user device to a server.
A method wherein a server generates a unique identification.
A method wherein the server associates the unique identification with review data, transaction data and metadata.
A method wherein the user device communicates with the server via internet protocol.
A method wherein after creation of the unique identification any subsequent communication between the server and the user device contains the user identification.
A method for paying for goods or services identified in transaction data via a payment processor on the user device, the method comprising on or more of: i) sending a notification of a completed payment from said payment processor to a host system; ii) sending a notification from payment processor to the server of a completed payment and associating and storing this information with the unique identification, review data, experience data and metadata on the database; iii) sending a notification of a completed payment from the server to the local computing system.
A method wherein the server sends a push notification to the local computing system to notify it of a completed payment.
A method wherein the local computing system receives the push notification from the server through a mobile device management platform.
A method wherein the host system is a point of sale device.
A method wherein the transaction data may comprise: names of ordered dishes corresponding to the configuration identifier; identification label of ordered dishes corresponding to the configuration identifier; categories of ordered dishes corresponding to the configuration identifier; prices of ordered dishes corresponding to the configuration identifier; location and staff data corresponding to the configuration identifier.
A method wherein when user review data is incomplete a prompt is generated on the user device post payment requesting the user complete the review.
A method further comprising a prompt on the user device requesting the user to provide registration data for example an email address or a social media account.
A method wherein the configuration data is provided to the local computing system.
A method wherein configuration data is transmitted to the server.
A method wherein the server obtains transaction data from a host system and stores it in the database.
A method wherein the server regularly polls the host system for updates to transaction data.
A method wherein the server requests specific transaction data from a host system based on configuration data received from the local computing system.
A method wherein the requests are made via a webhook.
A method wherein the server stores the transaction data and metadata in a database.
A system for associating, storing and identifying user review data, experience data, metadata and transmitting it to a user device, the system comprising: a host device; a user device; a server; a database; a computer system.
A method wherein the interactions with the Host system occur via a third-party integrator.
A method where a status device capable of displaying payment complete status of the local computing devices connected the system.
A method wherein the metadata comprises: total transaction value; status of the transaction, for example open or closed.
A system wherein the user device is mobile phone, smartphone, tablet, smartwatch or other item of wearable technology.

The invention also provides a computer program or a computer program product for carrying out any of the methods described herein, and/or for embodying any of the apparatus features described herein, and a computer readable medium having stored thereon a program for carrying out any of the methods described herein and/or for embodying any of the apparatus features described herein.

The invention also provides a signal embodying a computer program or a computer program product for carrying out any of the methods described herein, and/or for embodying any of the apparatus features described herein, a method of transmitting such a signal, and a computer product having an operating system which supports a computer program for carrying out the methods described herein and/or for embodying any of the apparatus features described herein.

Any apparatus feature as described herein may also be provided as a method feature, and vice versa. As used herein, means plus function features may be expressed alternatively in terms of their corresponding structure, such as a suitably programmed processor and associated memory.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

The following terms may be used interchangeably:
user, customer and consumer
host system, point of sale system.

In this specification the word ‘or’ can be interpreted in the exclusive or inclusive sense unless stated otherwise.

Furthermore, features implemented in hardware may generally be implemented in software, and vice versa. Any reference to software and hardware features herein should be construed accordingly.

One or more aspects will now be described, by way of example only and with reference to the accompanying drawings where like-reference numeral have been used to refer to like parts, in which:

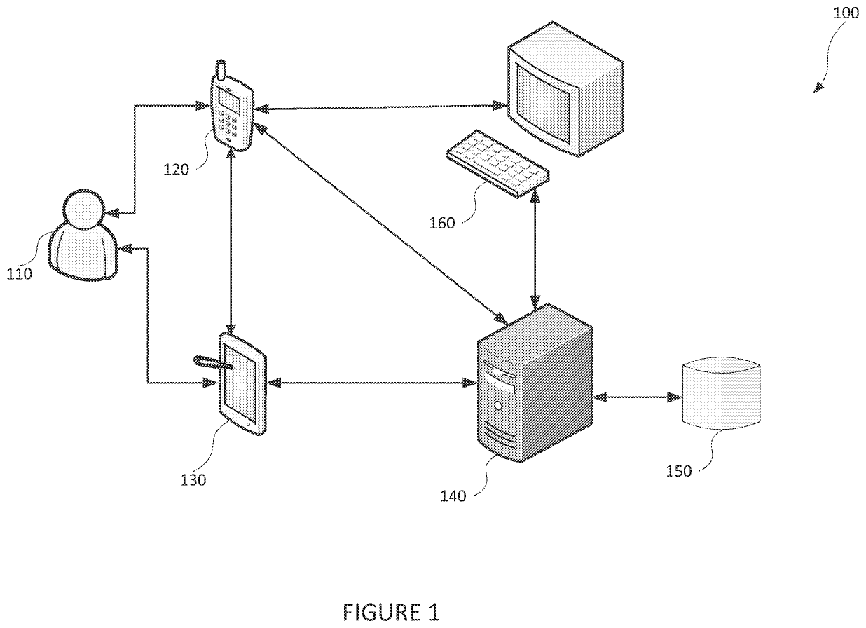

FIG. 1 is a schematic overview of a consumer tracking system capable of associating review data with a user device;

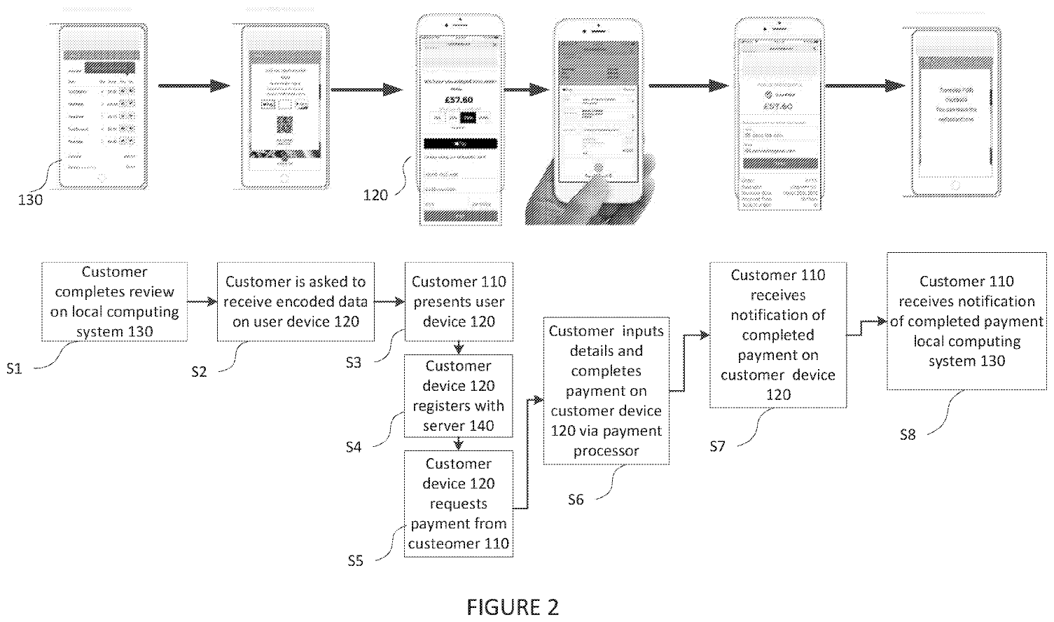

FIG. 2 shows an example of a possible user experience of the system of FIG. 1;

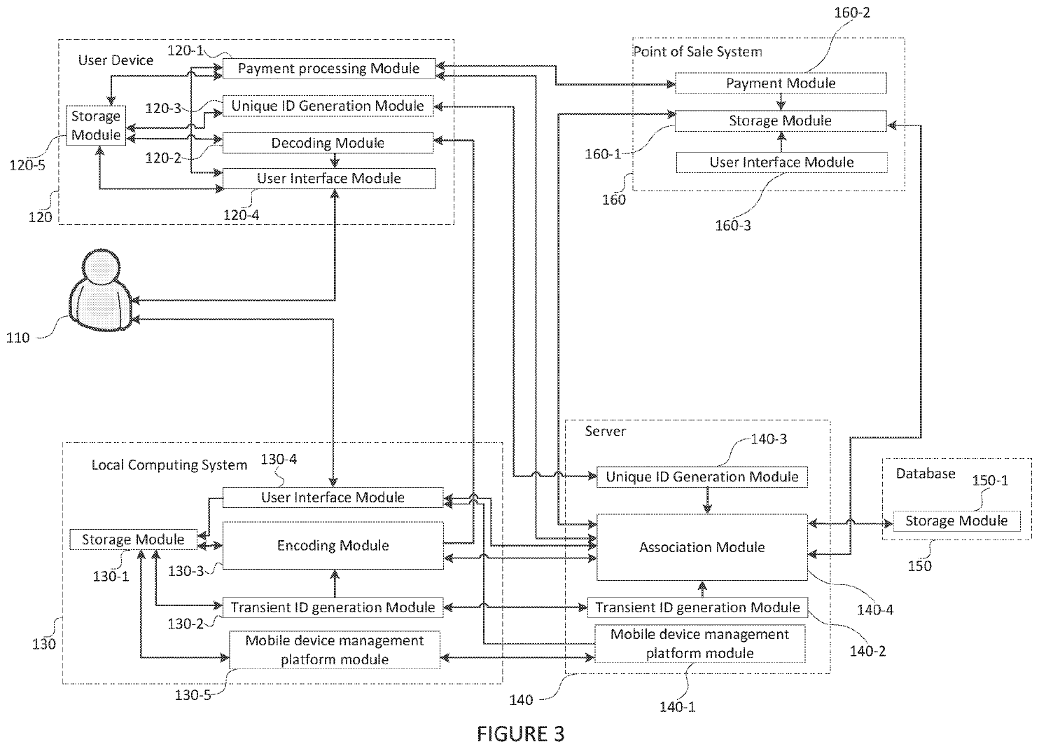

FIG. 3 shows a detailed schematic breakdown of the devices of the system;

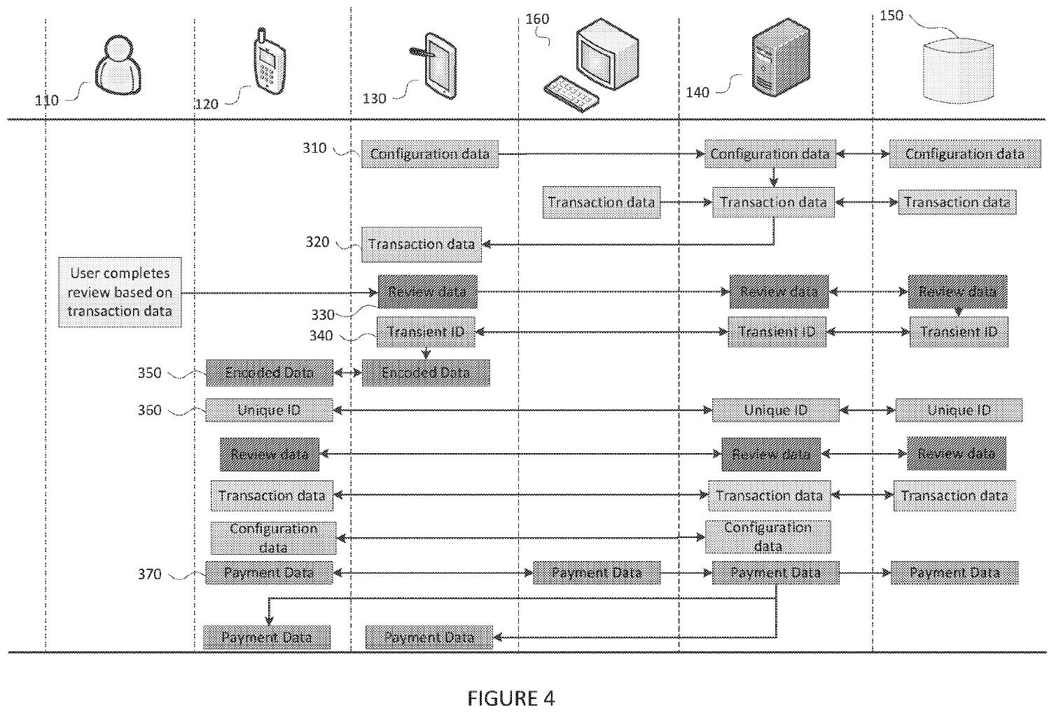

FIG. 4 shows an example of the possible data flows achievable with the system;

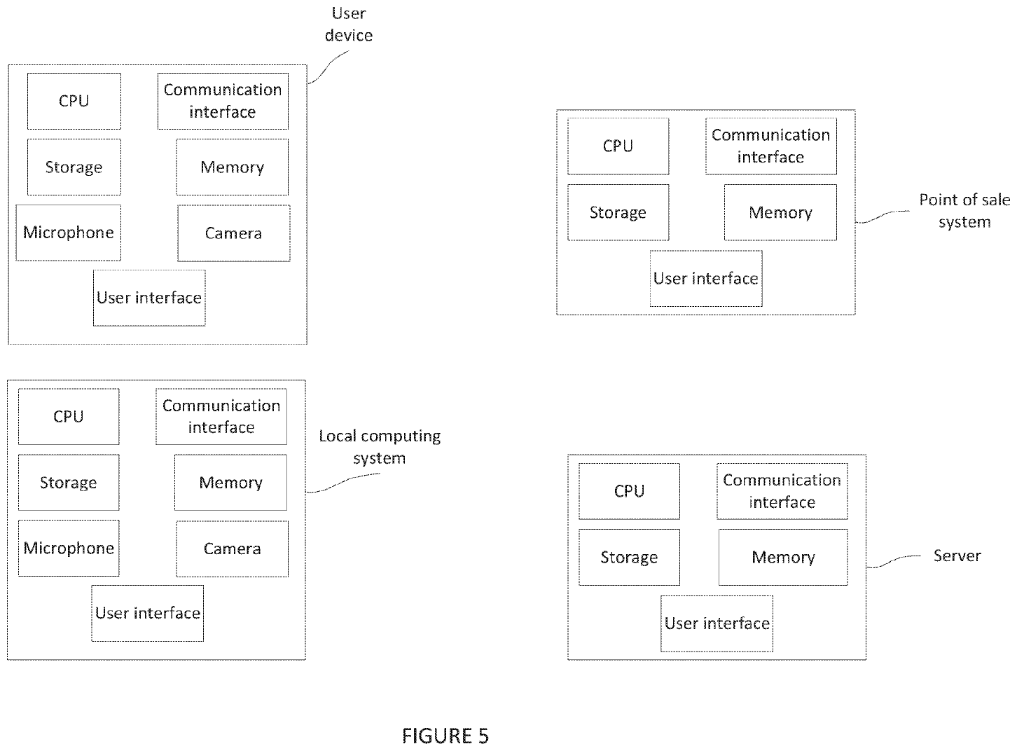

FIG. 5 shows a component breakdown of the devices in system;

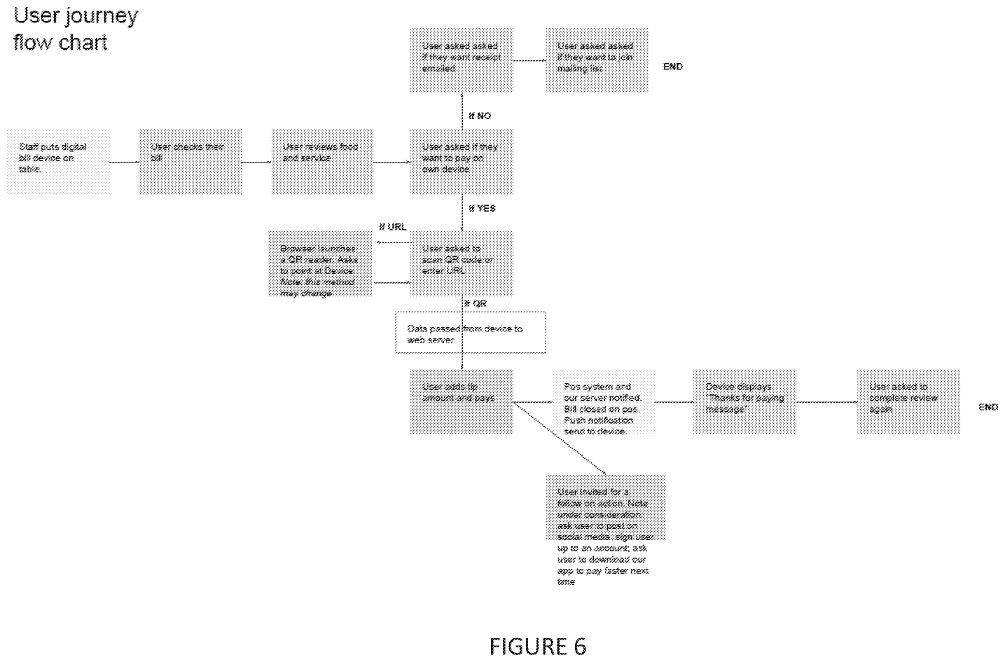

FIG. 6 shows a further example of a user interaction with system;

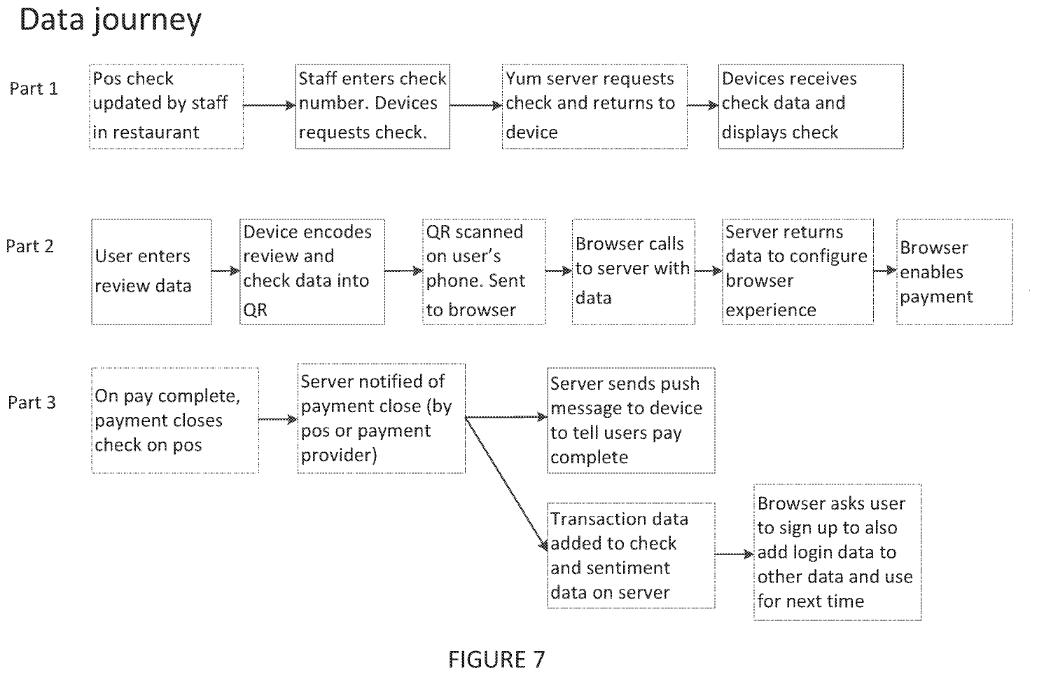

FIG. 7 shows a further example of the data flows through the system; and

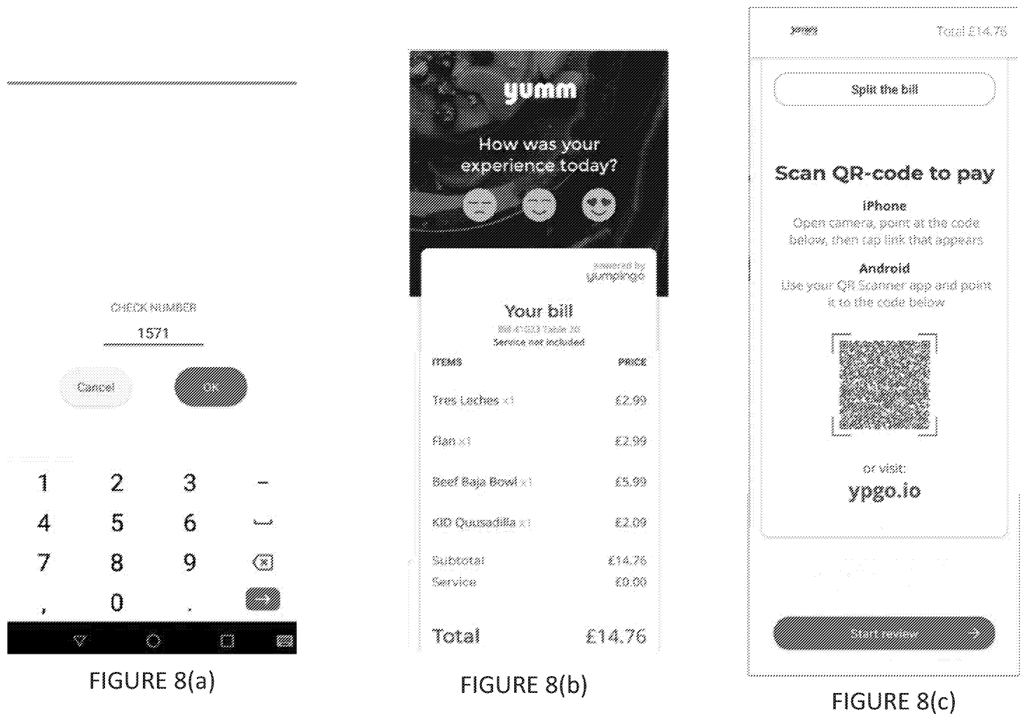

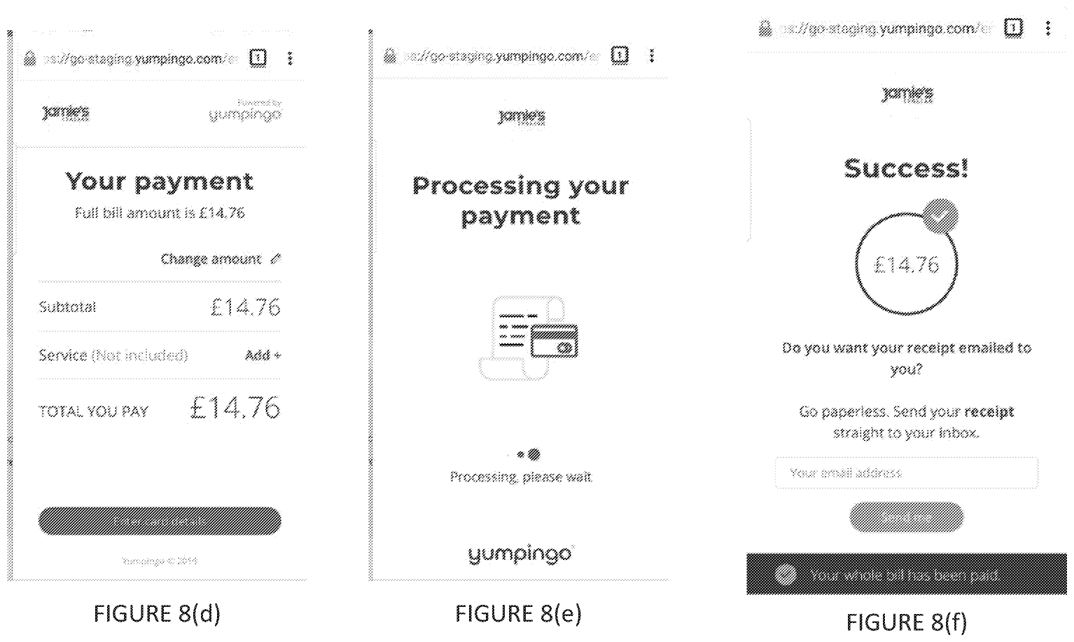

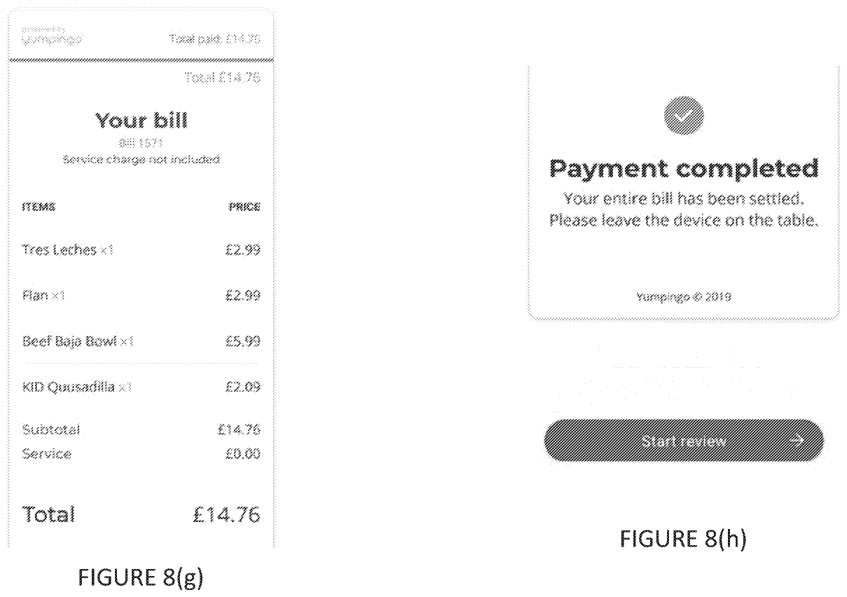

FIGS. 8a-8h show examples of a user interaction with a further embodiment of the consumer tracking system.

### OVERVIEW

FIG. 1 shows a schematic overview of a consumer tracking system 100, specifically for tracking interactions and sentiment data of user 110. User 110 may be in possession of a user device 120. A server 140 may be in communication with the user device 120, a local computing device 130, a host system 160 and a database 150.

The local computing device 130 provides the user 110 with an interface to system 100. The local computing system 130 enables the consumer to provide information about services that they may have received to the system 100, for example the local computing device 130 could be a tablet computer, a series of physical buttons corresponding to emotional moods or any other suitable means of collecting data. The local computing device 130 also acts as means of enabling the user 110 to connect to the system 100 using their own user device 120 for example the local computing system 130 could provide a QR code containing instructions which enable the user device 120 to connect to the server 140.

The host system 160 contains information about the services or goods provided to the user 110 for example it could a record of the items the user 110 has ordered. The information requested from the user 110 by the local computing device 130 may be based on information stored on the host system 160, this information can for example contain details of the services or items the user 110 has purchased.

When communicating with other devices in the system the point of sale system 160 may act independently or in combination with a third party integrator for example Omnivore. In such a way the third party integrator may facilitate communication between server 140 and point of sale system 160, and between user device 120 and point of sale system 160.

The server 140 mediates the interactions between the devices in the system 100, it executes requests form the other devices in the system and is capable of storing information in the database 150. For example, the server 140 may fulfil a request, made by the local computing system 130, for data stored in the database 150 or in host system 160.

The server 140 may transform data received from one device in the system 100 into a format which is understood by another. For example data received from the point of sale system 160 may be converted into a different format to be understood by local computing device 130.

In the example shown in FIG. 1 interactions between the local computing device 130 and the point of sale system 160 go via the server 140.

The server 140 enables information provided by the other devices in the system 100 to be associated with an identifier unique to that user 110 or user device 130.

The server 140 is also capable of analysing the data stored in the database 150 and can send the results of the analysis to any connected suitable devices connected to system 100.

Server 140 can form connections with other devices not shown in FIG. 1. In some embodiments server 140 and database 150 may be a single device. Individually or in combination the functions provided by server 140 and/or database 150 may be provided by a cloud computing solution.

The database 150 stores data received from the server 140.

The user device 120 may connect to the system 100 by receiving data from local computing device 130 containing instructions enabling it connect to server 140. The user device 120 may then receive information from server 140 or local computing device 130 for example details of the items the consumer orders, data from a review and/or information regarding past experiences with this particular host system 160. The user device 120 may also be further enabled to facilitate payment for the services or goods that have been provided to the user 110.

The user 110 is identified to the system 100 so as to allow the information provided by the user to the local computing device 130 to be associated to them for example the user could be identified through an electronic signature of their user device, a biometric identifier for example a fingerprint taken with the user device or the local device, a password entered into either the local computing or user device 120, or any by any other suitable means.

FIG. 2 shows a possible application of the system 100 in the context of a restaurant. In this case the user 110 is a customer at the restaurant. When the customer requests their bill from a member of staff, a staff member brings the customer the local computing device 130 which, in this example, is a tablet computer. The staff member enters the customer's table number into the tablet computer and hands the tablet to the customer. The table number may be entered by the staff member into a hidden input field on the local computing device 130.

Based on the table number the tablet retrieves the bill information from the point of sale system 160 which in this example could be a till or from the server 140.

The tablet displays the bill information along with a restaurant review based on the items from their bill for the customer to complete (S1). The customer 110 may also be then invited to answer some additional questions about their experiences that day.

The customer completes the review and is then invited to pay using their device (S2) or vice versa.

In this example the user device 120 is a mobile phone or smartphone. Information, such as items purchased by the customer and/or information if the customer enjoyed the meal, is transferred from the tablet computer to the mobile phone. In this particular example the information is transferred via a QR code (S3).

The user scans the QR code using their mobile phone—the data encoded in the QR code directs the mobile phone to register via an internet browser with the server 140 (S4).

In addition the data transferred via the QR code also instructs the user device to trigger a payment process (S5).

Once the customer completes the payment process (S6) they will receive a notification, informing them of the completed payment, on their mobile phone (S7) and additionally on the tablet computer (S8) at their table, this also allows staff members to see that a payment has been made.

On subsequent visits to the restaurant, or in fact to any establishment running the system 100, the server 140 is now capable of recognising the mobile phone and retrieving the associated historical data.

This historical data can then be used to tailor the user experience either on the user device 120 or on the local computing device 130.

Alternatively local computing system 130 may invite the user 110 to identify themselves to the system 100 using a unique identifier. This invitation may be issued to the customer at any point, it is not a requirement that it occur after the customer has requested the bill.

The user 110 may be invited by the local computing device 130 to connect their user device 110 to the system 100 at any point.

In the event that the user 110 does not wish to pay using the user device 120. The user 110 may still be invited to connect to the server 110 by local computing device 130.

The system 100 may be implemented for example in a restaurant, café or bar and the user may be a patron of the establishment. The local computing device 130 may be a tablet located in proximity to the user 110 for example at their table, on the bar etc, The server 140 (and/or database 150) may be located external to the premises for example it may be based in a cloud computing system communicated with via standard internet protocols. The point of sale system 160 may be located in the establishment.

The local computing device 130 is typically a portable device such as a tablet computer. The user device 120 is typically a portable device such as a tablet computer, mobile phone or smartphone, an item of wearable technology etc. Communication between the devices in system typically occurs wirelessly.

System 100 may contain one or many of the devices depicted in FIG. 1. For example when in use in a restaurant there may be a local device 130 placed on a plurality of tables each with a number of users 110 and user devices 120. It may also be efficient for the restaurant to utilise a plurality of point of sale systems 160 each interacting with a plurality of local devices 130. Furthermore there may be a plurality servers 140 to which the other devices in the system 100 can connect so that the volume of traffic to any one server is not so great as to affect the performance of that specific server 140.

### In Operation—Overview

System 100 is typically initialised by the input of configuration data into the local computing device 130. Configuration data may for example be a table number and may be inputted for example by a staff member, the user 110, or be obtained by some other means such as a GPS locator. The configuration data enables the local computing device 130 to request the information corresponding to the services provided to user 110 from host system 160 via the server 140. Local computing device 130 transmits the configuration data to server 140.

Server 140 requests transaction data and metadata from point of sale system 160 using the configuration data. Interactions between the server 140 and the point of sale system 160 may be mediated using a third party integrator. The transaction data may relate to the goods or services provided to the consumer 110 for example it may contain the prices and names of items purchased. The metadata may include further information about the goods or services that the consumer 110 has received for example data regarding who provided the consumer 110 with the good or services i.e. the name of a staff member.

Server 140 receives transaction data from the point of sale system 160 and transmits it to the database 150 for storage and to the local computing device 130.

Based on the received transaction data the local computing device 130 generates and displays a review for the user 110 to complete. Alternatively the review is generated by the server 140 and sent to the local computing device 130.

The local computing device 130 may also be initially configured with the data specific to the host system 160, such as for example the menu available at a restaurant

The user 110 completes the review.

The local computing device 130 creates a transient ID for the review data, configuration data, transaction data and metadata and transmits the review data, transaction data, configuration data and the transient ID to the server 140

The local computing device 130 may obtain the transient ID by using an algorithm embedded within the local computing device 130 or alternatively by requesting a transient ID from the server 140, and transmits the review data, transaction data and the transient ID to the server 140.

The server 140 tags the review data, transaction data and metadata with the transient ID and transmits it to the database 150 for storage.

Alternatively, the server 140 and local computing device 130 are in communication in such a way that the server 140 is capable of recognising that the review data and transient ID received from the local computing device 130 is associated with the transaction data, configuration data and metadata already stored on the database 150. In this alternative it the local computing device 130 is not required to transmit the transaction data, metadata and configuration back to the server 140.

In another possible embodiment the server 140 receives the review data from the local computing system 130 and generates the transient ID. The server 140 tags the review data, transaction data, metadata and configuration data with the transient ID. The server transmits the transient ID to the local computing device 130.

The local computing device 130 may encode a combination of the transient ID, configuration data, review data, transaction data and meta-data into a transport medium for example a matrix barcode.

The user 110 is requested by the local computing device 130 to receive the encoded data onto their user device 120.

The user device 120 decodes the encoded data and is instructed by the decoded data to register with server 140 and to provide a unique identification specific to user device 120.

Alternatively on registration of the user device 120, the server 140 generates a unique identification tag for user device 120.

Based on the transient ID received during registration the unique identification tag is then associated and stored with the review data, transaction data and metadata residing on the database 150.

Alternatively the configuration data, review data, transaction data and meta-data are transmitted from the user device 120 to the server 140. The server associates the unique identification tag with this data set and stores it in database 150.

In this way the database 150 now contains the information that is able to uniquely identify the user device 120 and the associated review data, transaction data, configuration data and metadata.

Furthermore the user 110 may then be requested by the user device 120 to make a payment based on the received transaction data. The user 110 completes the payment process on the user device 120. The user device 120 communicates with the point of sale system 160 and the server 140 that the payment has been completed. The server 140 associates and stores payment complete data with the transaction data, review data and metadata in database 150 and sends a notification of the completed payment for example a receipt to the user device 120 and the local computing device 130.

### In Operation—Detail

FIG. 3 shows a more detailed schematic diagram of the possible interactions between the various components (hardware and software) of system 100.

FIG. 4 shows an example of the typical data transmitted between the components of system 100.

A staff member is prompted by the user interface module 130-4 of the local computing device 130 to enter configuration data 310. The configuration data 310 may for example comprise:
the bill identifier;
the table identifier;
the staff member or waiter identifier.

The user interface module 130-4 transmits the received configuration data 310 to the association module 140-4 of the server 140. This transmission can occur for example via an internet protocol such as HTTPS. The association module 140-4 stores the configuration data 310 in storage module 150-1 of the database 150. The association module requests the transaction data 320 and metadata from the storage module 160-1 of the point of sale system 160 or from the storage module 150-1 of the database 150, where it may previously have been stored.

Transaction data 320 may be entered into the point of sale system 160 by for example a member of staff via the user interface module 160-3 and stored on the storage module 160-1. The transaction data may comprise for example:
information pertaining to a bill for example: names, restaurant identifiers, categories and prices of the items that has been ordered by the user 110;
location and staff data.

The storage module 160-1 of the point of sale system may additionally store metadata. The metadata may comprise for example:
the total bill value;
the status of the bill (open/closed);
the data about the staff member who served the table

The request from the association module 140-4 of the server 140 may be made via a third party integrator which has been integrated with the point of sale system 160 for example Omnivore. In all interactions with the point of sale system 160 the devices of system 100 may be acting independently or in combination with a third party integrator.

The association module 140-4 of server 140 may obtain the transaction data 320 and metadata from the point of sale system 160 in a number of different ways for example:
the association module 140-4 may seek regular updates from the storage module 160-1 of the point of sale system 160 via for example a webhook for example a web callback or HTTP push API. For example the server 140 may receive an update when a new bill is entered into the point of sale system 160, or when a change is made to an existing bill. Once the association module 140-4 receives an update it stores it in the storage module 150-1 of database 150; and/or
the association module 140-4 may request a live version of a specific bill from the storage module 160-1 based on the configuration data 310.

The association module 140-4 stores the received transaction data 320 and metadata in the storage module 150-1 of the database 150.

The server 140 may also create new data properties based on the transaction data 320 and metadata received from the point of sale system 160 for example new dishes. The server 140 may also merge data from the storage modules 160-1 and/or 150-1 with the transaction data for example the identities of previously saved dishes.

The association module 140-4 converts the transaction data 320 received from the point of sale system 160 into a format readable by the local computing device 130 and transmits the transaction data 320 and metadata to the user interface module 130-4 of the local computing device 130.

On receiving the transaction data 320 and metadata the user interface module 130-4 of the local computing device 130 generates a review for the user to complete based on the transaction data 320. Alternatively the review is generated on server 140 and transmitted to the local computing device 130 with the transaction data 320 and metadata.

The user interface module 130-4 of the local computing device 130 displays a digital representation of the bill to the user 110 and invites the user 110 to examine their bill and complete the restaurant review. The local computing device 130 updates the review data 330 based on the information provided by the user 110.

After completion of the review the transient ID module 130-2 of the local computing device 130 generates a transient ID 340 for the review data 330, transaction data 320 and meta-data. The transient ID is then transmitted to the association module 140-4 of the server 140 and to the encoding module 130-3 of the local computing device 130.

Alternatively the transient ID 340 may be created by the transient ID module 140-2 of server 140 and transmitted to the encoding module 130-3 of the local computing device 130.

The transient ID 340 may therefore be created by the server 140 and returned to the local computing device 130 with the configuration data 310. Alternatively the transient ID 340 may be encoded on local computing device 130 directly by using an algorithm and/or private key which the server 140 will then be able to decode once it receives it either from the local computing device 130 or user device 120.

The user device may send the review data 330 and transaction data 320 to the server 140 so that it can be saved to the database 150 and made available for the user device 120 at a later point.

The encoding module 130-3 of the local computing device 130 encodes data into a transport medium and transmits the encoded data 350 from the local computing device 130 to the decoding module 120-2 of the user device 120. The encoded data 350 can contain a plurality of different combinations of data; three examples of the type of data that may be included are:
the configuration data 310, the review data 330, transaction data 320, transient ID 340 and metadata;
the transient ID data 340.
the review data 330, transaction data 320, the configuration data 310 and metadata.

The transient ID data 340 may contain instructions that once decoded on the user device 120, instruct the user device 120 to register with the server 140. For example the transient ID may comprise a URL which the user device will then be instructed to visit.

Alternatively the instructions for connecting to the user device 120 to the server are included in the transport medium or encoded data 350. In some embodiments it is possible that the encoded does not contain a transient ID, the review data 330, transaction data 320, the configuration data 310 and metadata are encoded and transmitted to the user device 120. The user device 120 may then transmit these to server 140 where they are stored in database 150.

The transport medium may be for example:
A matrix barcode for example a QR code: the user device scans the QR code, using the decoding module. A link may be provided to a web URL which provides a QR reader for the user device.
A barcode: the user device scans the barcode code, using the decoding module. A link may be provided to a web URL which provides a QR reader for the user device.
A URL plus alphanumeric code: The user visits a URL and enters a code
A URL plus QR/Barcode: the user visits a URL in their web browser which loads up a scanner and invites the user to scan the QR/Barcode using the user device 120
Near field communication (NFC): the user device is placed in proximity to the local computing system and the decoding module receives the data
Bluetooth: the user device 120 connects to the local computing device 130 via Bluetooth.

Once decoded the transient ID 340 instructs the user device 120 to register with the server 140. The user device 110 typically communicates with the server 140 using an internet protocol for example HTTPS via a browser contained in the user interface module 120-4.

On registration with the server 140 or at any subsequent point the transaction data 320, configuration data 310, metadata and review data 330 may be transmitted to the user device 120 from the server 140.

The encoded data 350 therefore allows the review data 330, configuration data 310 transient ID 340 and metadata to “piggy back” on the transaction data 320 to the user device 120. For example it allows the user device 110 to simultaneously receive the transaction data 320, review data 330, configuration data 310 and metadata. The system 100 effectively bounces the user 110 from local device 120 to user device 110 and then back again; effectively facilitating the transfer of the review data which may contain information about the sentiment of user 110 from the local device 130 to the user device 120.

In some embodiments the user interface module 120-4 configures the browser experience on the user device 120 in response to the data received either from the server 140 or in the encoded data 350. For example if the user 110 has recorded a positive experience in the review data 330 for a particular dish at the restaurant the browser experience could then be used to suggest other similar dishes available at that establishment or other similar establishments.

On registration with the server 140 the user device 120 creates a unique identification 360 and sends it to association module 140-4 of the server 140.

Alternatively the server 140 may create the unique identification 360.

The unique identification 360 may comprise a cookie for example a HTTP cookie such as a persistent cookie, which may be generated by the server 140 and returned to the user device 120. In the case where user device 120 has no cookie stored then it will request one from server 140, server 140 will then generate a cookie and return it to user device 120. Subsequent communication between user device 120 and server 140 will involve the cookie.

The association module 140-4 tags the review data, transaction data and user data with the unique identification based on the transient identification and stores the associated data in database 150.

After the creation of the unique ID 360 all subsequent communication between the local computing device 130 and server 140 may contain the unique identifier 360.

The unique identification 360 is used by the server 140 to retrieve all necessary data required by the user device 120 from the database 160 and return this data to the user device 120. The user device 120 can utilise this data to customise the experience of user 110.

The user interface module 120-4 of user device 120 may prompt the user 110 to complete a payment using the payment processor module 120-1 of the user device 120. The payment processor module 120-1 may for example be a third party mobile payment application such as a web-based credit card processor, Apple Pay, Google Pay or PayPal. Alternatively the payment processor module 120-1 may provide access to a website through which a payment processor may be selected.

The communication between both the payment processor module 120-1 and the point of sale system 160 typically occurs directly using an internet protocol such as HTTPS. This interaction may be mediated by a third party integrator between the point of sale system 160 and the user device 120.

The user 110 enters their payment details into the payment processor module 120-1 via the user interface module 120-4 of the user device 120. Once payment is completed either the point of sale system 160 or the payment processor module 120-1 notifies the server 140 of the completed payment. On receipt of the payment complete notification the point of sale system 160 may close the bill.

The communication between the payment processor module 120-1 and the point-of-sale system 160 and server 140 typically occurs directly using an internet protocol such as HTTPS.

On receiving the payment data 370 the association module 140-4 of the server 140 uses the unique identifier 360 to tag the data and store it with the associated data in the storage module 150-1 of the database 150.

On completion of the payment, the user interface module 120-4 may display a payment complete message to the user 110 and may invite the user 110 to take further actions, such as participating in a further review, signing up to a user account via an email address or providing information about their social media accounts.

Additionally on receipt of the payment data 370 the server 140 may send a push notification using the mobile device management platform module 140-1 to the user interface module 130-4 of the local computing device 130 via the mobile device management platform 130-5. It should be recognised that mobile device management platform modules 130-5 and 140-1 comprise a mobile device management solution, which is a custom built layer that sits on top of the Android device management APIs. The mobile device management solution allows the server 140 to communicate with a number of local computing systems 130, without it the implementation of the system 100 would be impractical at any scale. In this example the payment data 370 has been transferred from the user device 120 to the local device 130 via the server 140.

On receipt of the push notification the user interface module 120-4 may display a payment complete message to the user 110.

Additional push notifications from the mobile device management platform 140-1 may invite the user 110 to take further actions such as completing a previously incomplete review, participating in a further review, signing up to a user account via an email address or providing information about their social media accounts.

Any further information provided by the user 110 on either local computing device 130 or user device 120 is sent to the server 140 and associated with the stored data via the association module 140-4 and saved in the storage module 150-1 of the database 150 where it can be retrieved later for future use.

Additional devices capable of receiving and displaying push notifications may be added to system 100. One example of such a device could be a status device configured to receive notifications from server 140 to provide an overview of the completed payments for every user device 120 and/or local computing device 130 in a certain location in communication with the server 140.

FIG. 5 shows an example of the additional hardware components that may be required for the devices of FIG. 1 to implement the modules detailed in FIG. 3. In this example each device comprises:
a central processing unit capable of executing instructions stored in the memory. The memory may comprise for example both random access memory and read only memory and stores the instructions for the CPU.
storage, for example a hard disk or flash drive provides mass storage of data for the device.
A user interface allowing a user to interact with the device and
a communication interface allowing the device to connect with other electronic devices wherein a communication interface may be for example a wifi adapter, Bluetooth adapter, NFC adapter, Ethernet port. The devices may contain several different communication interfaces which will vary depending on the device. The user interface may vary depending on the device for example it could be a touch screen, a keyboard and mouse, or other suitable alternatives.

FIG. 6 shows a further example of a user interaction with system 100.

FIG. 7 shows a further example of the data flows through system 100.

In certain examples methods or systems may also enable:
Retaining the review data so as to enable the creation of a customised taste profile of the user 110.
Retaining review data from a plurality of users so as to enable recommendations to be made based this review data.

FIGS. 8a-8h show a user interaction with a further embodiment of the system 100.

Referring to FIGS. 8a-8c, operations that occur on the local computing device 130 are shown.

As shown in FIGS. 8a, the local computing device 130 is arranged to receive configuration data (in this embodiment a table number). As shown in FIG. 8b, on receipt of the configuration data the local computing device 130 presents a bill relating to the configuration data. The bill may be modifiable, for example the user 110 may be able to add a tip. In some embodiments, the display presented by the local computing device 130 includes review options, so that the user 110 is able to leave a review using the local computing device 130. As shown in FIG. 8c, following display of the bill, the local computing device 130 presents an interactive element to the user 110. In this embodiment, the local computing device 130 presents a QR code, which the user 110 can scan using the user device 120. As described with reference to FIG. 8b, prior to scanning the QR code the user has the option to conduct a review about their experience on the local device; the result of this review is typically made available on the user device 120 after the user scans the QR code.

The QR code (or other interactive element) comprises the configuration data. The user device 120 is able to receive the configuration data by scanning the code and thereafter can send the configuration data to the server 140 and receive, in return, payment information relating to the configuration data (e.g. the bill details). It will be appreciated that the data transmitted from the local computing device 130 to the user device 120, and from the user device 120 to the server 140 does not need to be in exactly the same format as the data initially received by the local computing device 130 so long as each data is suitable for identifying the customer/service (e.g. the data received by the local computing device 130 may be a table number, the data contained in the QR code may be an alphanumeric code relating to that table number).

Referring to FIGS. 8d-8f, operations that occur on the user device 120 following the scan of the QR code are shown.

As shown in FIG. 8d, once the user 110 has scanned the QR code, a payment screen is provided on the user device 120. In this embodiment, the user 110 is able to modify the payment at this stage, e.g. to add a tip. The user 110 can then pay the bill, for example by entering a card number or by connecting to a payment service such as Paypal™. As shown in FIG. 8e, following entry of payment details, a processing screen is shown to the user 110 while payment is being processed. As shown in FIG. 8f, following a successful payment, a success screen is shown to the user 110 on the user device 120. This screen offers the user 110 the option of receiving a receipt on the user device 120. If a payment is not successful, instead of a success screen there is typically shown a screen that offers the user 110 a chance to enter alternative payment details.

In some embodiments, following the user review further action is taken in dependence on the review, e.g. in dependence on whether the review was positive or negative. As an example, if the review is positive, the user 110 might be asked to post a review on social media; if the review is negative, the user 110 might be offered contact details for a customer feedback helpline of the establishment.

Referring to FIGS. 8g and 8h, operations that occur on the local computing device 130 following payment are shown.

As shown in FIG. 8g, following payment, the local computing device 130 displays a screen that indicates the payment has been completed. Following this, as shown in FIG. 8h, the local computing device 130 provides an option to leave a review. Typically, the staff member confirms that the payment has been completed and then leaves the local computing device 130 on the table for the user 110 to complete a review. Upon choosing to leave a review, the user is shown a review screen—this review screen may also be shown immediately following completion of payment.

In some embodiments, the option to leave a review is also presented (or instead presented) on the user device 120, so that the user 110 is able to leave a review after leaving the establishment.

It will be appreciated that many of the steps described with reference to FIG. 8 are optional, for example, the local computing device 130 may be arranged to receive an identifier and thereafter immediately present a QR code that can be scanned by the user. Payment may then take place entirely on the user device 120, where the payment completion screen on the local computing device 130 shows only that payment has been completed (without showing how much has been paid). This enables the user 110 to leave a tip without feeling self-conscious. Similarly, the review may take place entirely on the user device 120.

It will also be appreciated that many of the steps described with reference to FIG. 8 may be performed in an alternate order. For example, the review screen may be presented to the user 110 before the payment screen, so that the user 110 is able to complete a review before providing payment information.

In some embodiments, the user 110 is shown a review screen while the payment is being processed, e.g. the user 110 is shown a review screen instead of the payment processing screen of FIG. 8e. This enables the user to review the service while the payment is being processed, which saves time and prevents the user from being bored while the payment is processed.

In some embodiments, no payment information and/or no review information is accessed by the local computing device 130 at all. In these embodiments, the local computing device 130 is arranged to present a unique identifier (e.g. QR code) to the user 110. Once the user device 120 has scanned the QR code, the user device 120 communicates with the point of sale system 160 to retrieve payment information. Specifically, the user device 120 transmits the unique identifier to the point of sale system 160 and in return receives payment information. In these embodiments, the only necessary function of the local computing device 130 is receiving an identifier and presenting to the user a QR code (or another element with which the user 110 can interact to connect to the system 100, such as an NFC signal).

### Alternatives and Extensions

The system and method have been described by way of example, and many alternative implementations will occur to the skilled person. In particular, any described method steps may be performed out of the described order.

The present invention has been described above purely by way of example, and modifications of detail can be made within the scope of the invention, for example, in some embodiments there are multiple users 110 and/or multiple user devices 120; this might be the case where a number of customers split a bill. In these embodiments, the local computing device 130 may present the same configuration data to each user and/or may present different configuration data to each user. Typically, along with the payment request a different identifier is sent to each user device. Each user can then be individually identified (and associated with a review) if that user returns to the establishment. In some embodiments, each different identifier is connected, so that if any of the users return to the establishment it can be identified that the returning user had previously been in a group with another of the users.

Each feature disclosed in the description, and (where appropriate) the claims and drawings may be provided independently or in any appropriate combination.

Reference numerals appearing in the claims are by way of illustration only and shall have no limiting effect on the scope of the claims.

1. A computer implemented method, the method comprising:
receiving, on a local computing device, configuration data identifying a transaction or service provided to a user;
wherein the configuration data is arranged to enable a user device to access a payment request in respect of the transaction or service and an identifier dependent on the transaction data;
wherein the identifier comprises server access information adapted to enable the user device to access a server with the identifier thereby enabling an association or link to be made at the server between the user device and review data in respect of the transaction or service.

2. A method according to claim 1, further comprising
requesting and receiving, either on the local computing device or on the user device, from a remote server in dependence on the configuration data transaction data relating to the transaction or service;
requesting and receiving, either on the local computing device or on the user device, from the user review data in respect of the transaction or service and forwarding said review data to the server; and
transmitting to the user device a payment request in respect of the transaction or service and an identifier dependent on the transaction data.

3. A method according to claim 2, further comprising transmitting the configuration data to the user device.

4. (canceled)

5. A method according to claim 1, wherein the configuration data is at least one of: received via direct input at the local computing device, received from a remote server, and determined in dependence on proximity or location data.

6. A method according to claim 1, wherein the review data is requested from the user via a review interface, the interface generated by the local computing device or received from the server.

7. A method according to claim 1, wherein the identifier is generated by the local computing device or received from the server.

8. A method according to claim 1, wherein the identifier and server access information are encoded into a transport medium readable by the user device such as a barcode, QR code, or URL and/or transmitted via a wireless protocol such as NFC or Bluetooth.

9. A method according to claim 1, wherein the server access information comprises instructions to the user device to access the server.

10. A method according to claim 1, further comprising forwarding to the user device further data in dependence on at least one of: review data and/or transaction data.

11. A local computing device, the device comprising:
means for receiving configuration data identifying a transaction or service provided to a user;
means for requesting and receiving from a remote server in dependence on the configuration data transaction data relating to the transaction or service;
means for requesting and receiving from the user review data in respect of the transaction or service and forwarding said review data to the server; and
means for transmitting to the user device a payment request in respect of the transaction or service and an identifier dependent on the transaction data;
wherein the identifier comprises server access information adapted to enable the user device to access the server with the identifier thereby enabling an association or link to be made at the server between the user device and the review data in respect of the transaction or service.

12. (canceled)

13. (canceled)

14. (canceled)

15. A local computing device according to claim 11, wherein the configuration data is at least one of: received via direct input at the local computing device, received from a remote server and/or determined in dependence on proximity or location data.

16. A local computing device according to claim 11, wherein the identifier is generated by the local computing device or received from the server.

17. A local computing device according to claim 11, wherein the identifier and server access information are encoded into a transport medium readable by the user device such as a barcode, QR code, or URL and/or transmitted via a wireless protocol such as NFC or Bluetooth.

18. A local computing device according to claim 11, wherein the server access information comprises instructions to the user device to access the server.

19. A local computing device according to claim 11, further comprising means for forwarding to the user device further data in dependence on at least one of: review data and/or transaction data.

20. A method performed on a computer server, the method comprising:
providing, in response to a request received from a local computing device or a user device, transaction data relating to the transaction or service provided to a user;
receiving from the local computing device or the user device review data in respect of the transaction or service;
receiving a connection request from the user device, the request comprising an identifier provided by the local computing device and dependent on the transaction data; and
associating the user device to the review data in respect of the transaction or service.

21. A method according to claim 0, further comprising:
receiving configuration data identifying a transaction or service from the local computing device; and
requesting and receiving transaction data relating to the transaction or service from an external entity such as a point-of-sale system.

22. (canceled)

23. (canceled)

24. (canceled)

25. A computer program and computer program product comprising computer code which when executed is adapted to perform the method of claim 1.

26-34. (canceled)

35. A computer program and computer program product comprising computer code which when executed is adapted to perform the method of claim 20.

36. A server adapted to perform the method of claim 20.
